(19) United States
(12) Patent Application Publication
(10) Pub. No.: US 2014/0306450 A1
(43) Pub. Date: Oct. 16, 2014

(54) ELECTRICAL MACHINE AND WIND POWER GENERATING SYSTEM

(71) Applicant: HITACHI, LTD., Tokyo (JP)

(72) Inventors: Daisuke SATOH, Tokyo (JP); Mamoru KIMURA, Tokyo (JP); Nobuhiro KUSUNO, Tokyo (JP); Masahiro HORI, Tokyo (JP)

(73) Assignee: HITACHI, LTD., Tokyo (JP)

(21) Appl. No.: 14/223,101

(22) Filed: Mar. 24, 2014

(30) Foreign Application Priority Data
Apr. 10, 2013 (JP) 2013-081755

(51) Int. Cl. F28D 15/02; F03D 11/00

(52) U.S. Cl. CPC F28D 15/02; F03D 11/00
USPC 290/2

(57) ABSTRACT

A electrical machine and a wind power generating system include a stator having a stator winding, a rotor arranged on a side of an inner diameter of the stator with a clearance between the rotor and the stator, a shaft fixed to the rotor and rotated along with the rotor, and a heat pipe arranged from an inner portion over to an outer portion of the shaft, and a radius of gyration of a portion of the heat pipe arranged at the outer portion of the shaft is smaller than that of a portion arranged at the inner portion of the shaft.

### BACKGROUND

The invention relates to an electrical machine and a wind power generating system and more particularly to an apparatus of cooling an electrical machine by using a heat pipe.

In recent years, attention is highly attracted to natural energy owing to global warming, a steep rise in fuel price, a danger in electric power and the like. In wind power generation using a wind power which is one of natural energies, energy of a wind is converted into an electric energy by an electrical machine. When the rotating electric power is operated, an inner temperature thereof rises by generating heat by a copper loss or an iron loss. The rise in the inner temperature brings about deterioration in an electrical insulator used in a coil or an iron core, which amounts to low service life of the electrical machine. Therefore, it is indispensable to cool the electrical machine for preventing the occurrence.

Cooling by a heat pipe is pointed out as a method of cooling the electrical machine. According to the cooling method, a rotor is cooled by using a heat pipe containing a working fluid at inside thereof. The heat pipe is embedded in a rotating shaft. At high speed rotation, the working fluid in the heat pipe sticks to an inner wall of the heat pipe by operating a centrifugal force by rotating the rotating shaft, which amounts to a reduction in a thermal conductivity by an increase in a thermal resistance of a condenser.

Here, there are electrical machines including heat pipes described in, for example, Japanese Unexamined Patent Application Publication No. Sho63 (1988)-183384 and Japanese Examined Patent Application Publication No. Sho61 (1986)-21354. According to the both patent literatures, the following countermeasures are worked out against sticking of the working fluid to an inner wall of the heat pipe. That is, according to Japanese Unexamined Patent Application Publication No. Sho63-183384, the working fluid is prevented from sticking to a pipe wall by moving the working fluid from a condenser to an evaporator by using a centrifugal force by configuring a taper at an inner wall of the heat pipe. Also, according to Japanese Examined Patent Application Publication No. Sho61 (1986)-21354, the working fluid is prevented from sticking to a total of a pipe wall of the condenser by gathering the working fluid to a working fluid storage by using a centrifugal force by configuring the working fluid storage by an inner peripheral wall at a condenser of the heat pipe.

### SUMMARY

According to Japanese Unexamined Patent Application Publication No. Sho63 (1988)-183384, when the taper is small, a component of the centrifugal force for moving the working fluid to the evaporator becomes small. Therefore, an effect of preventing sticking of the working fluid is reduced, and the thermal conductivity of the heat pipe is reduced at high speed rotation. On the other hand, when sticking of the working fluid is prevented by enlarging the taper, a pipe wall of the heat pipe in the condenser is thickened, the thermal conductivity of the heat pipe is reduced owing to an increase in a fluid resistance of the heat pipe and an increase in a thermal resistance of the pipe wall.

According to Japanese Examined Patent Application Publication No. Sho61 (1986)-21354, sticking of the working fluid to the total of the pipe wall is prevented by deviating the working fluid to the working fluid storage decentered from a rotational axis by configuring an inner peripheral wall at a cooling area. However, the thermal conductivity of the heat pipe is reduced by increasing a contact thermal resistance between the pipe wall of the heat pipe and the inner peripheral wall, a thermal resistance provided to the inner peripheral wall, and an increase in a fluid resistance by installing the inner peripheral wall.

The present invention has been carried out in view of the matters described above, and it is an object thereof to provide an electrical machine or a wind power generating system improving a cooling performance without reducing a thermal conductivity.

In order to address the problem described above, according an aspect of the present invention, an electrical machine includes a stator having a stator winding, a rotor arranged on an inner diameter of the stator with a clearance therebetween, a shaft fixed to the rotor and rotated along with the rotor, and a heat pipe arranged from an inner portion over to an outer portion of the shaft, and a radius of gyration of a portion of the heat pipe arranged at the outer portion of the shaft is smaller than that of a portion of the heat pipe arranged at the inner portion of the shaft.

According to another aspect of the present invention, a wind power generating system includes the electrical machine described above, a blade rotated by receiving a wind, and a main shaft rotated in accordance with a rotation of the blade, and the rotor of the electrical machine is rotated by rotating the shaft in accordance with a rotation of the main shaft.

According to the aspects of the present invention, an electrical machine or a wind power generating system improving a cooling performance can be provided.

### BRIEF DESCRIPTION OF THE DRAWINGS

FIG. 1 is a sectional view in an axial direction of an electrical machine in which a heat pipe is embedded into a shaft;

FIG. 2 is a sectional view in an axial direction of a shaft portion at high speed rotation in a first embodiment of a cooling apparatus of an electrical machine;

FIG. 3 is a sectional view in an axial direction of a shaft portion at high speed rotation of a second embodiment of a cooling apparatus of an electrical machine;

FIG. 4 is a sectional view in an axial direction of a shaft portion at high speed rotation in a third embodiment of a cooling apparatus of an electrical machine; and

FIG. 5 is an outline view of a wind power generating system according to a fourth embodiment.

### DETAILED DESCRIPTION

A detailed description will be given of embodiments of the present invention in reference to the drawings as follows. Incidentally, the undermentioned description is strictly an embodiment and does not mean to intend to limit the mode of the invention only to the embodiment. For example, although an explanation is given of a case of using rotor windings as described below, a permanent magnet can be provided instead of providing the rotor windings.

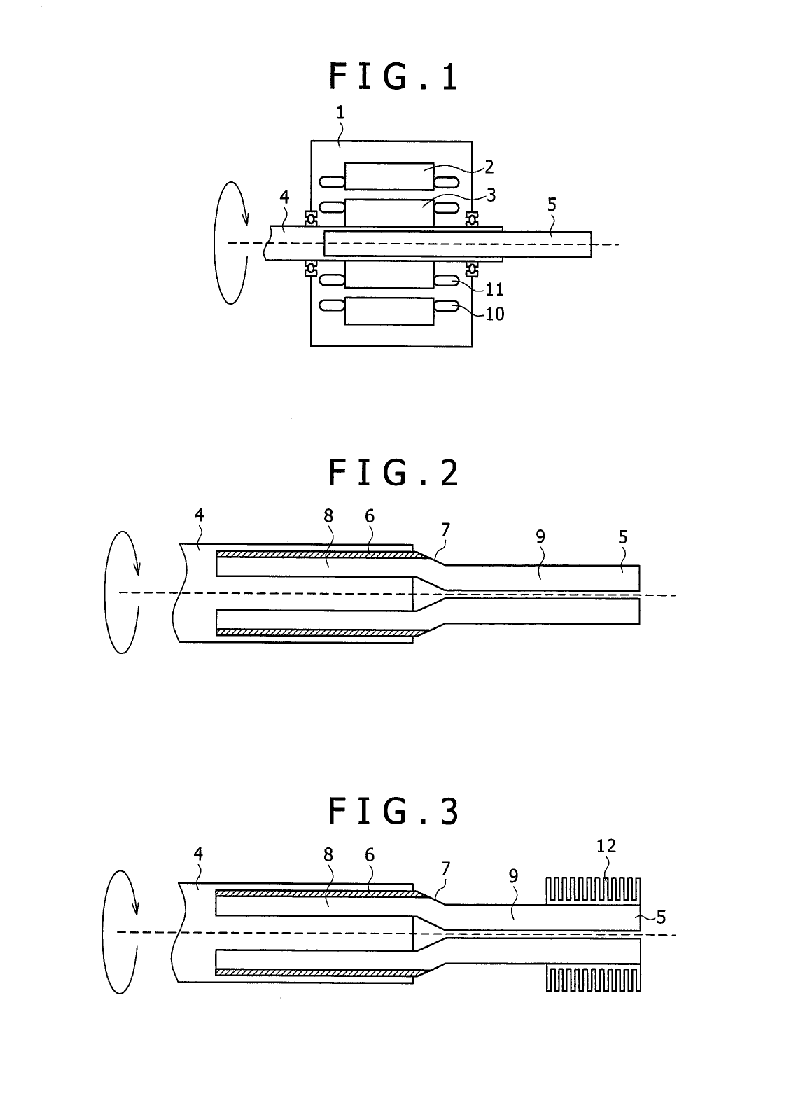

First, an explanation will be given of a total structure of an electrical machine including a heat pipe in reference to FIG. 1. Incidentally, FIG. 1 is a reference figure, which is not drawn such that a position in a diameter direction of a heat pipe is changed over an axial direction as will be explained in the respective embodiments as follows.

A electrical machine 1 shown in FIG. 1 includes a stator 2, a rotor 3 arranged on an inner diameter side of the stator 2 by providing a clearance therebetween, three-phase stator windings 10 wound in, for example, two layers in a slot provided at the stator 2, and three-phase rotor windings 11 wound in, for example, two layers in a slot provided at the rotor 3. Incidentally, respective phases of the three-phase stator windings 10 and the three-phase rotor windings 11 are arranged electrically at intervals of 120°. The rotor 3 is supported by a shaft 4 and is rotated along with the shaft 4. An inner portion of the shaft 4 is hollowed, and a heat pipe 5 is arranged in a state of being brought into contact with an inner wall of a hollowed portion of the shaft 4. An explanation will be given of a shape of the heat pipe and the like in individual embodiments as follows.

### First Embodiment

A first embodiment will be explained in reference to FIG. 2. FIG. 2 shows a sectional view in an axial direction of a shaft portion at high speed rotation of a cooling apparatus of an electrical machine according to the first embodiment. An evaporator 8 of the heat pipe 5 arranged at an inner portion (inner diameter side) of the shaft 4 becomes an area in contact with an inner wall of the shaft 4, and a condenser 9 of the heat pipe 5 arranged at an outer portion of the shaft 4 (an outer side in a long axis direction of the shaft 4) becomes an area projected from the shaft 4. The heat pipe 5 is constructed by a structure of being bent by a bending portion 7 disposed between the evaporator 8 and the condenser 9. The condenser is arranged to be more proximate to the shaft 4 (more accurately, rotational axis) than the evaporator 8 in a diameter direction, and an eccentricity from the shaft 4 (more accurately, rotational axis) becomes smaller. That is, a radius of gyration of the condenser 9 is smaller than that of the evaporator 8. The heat pipe 5 is configured such that a flow path thereof has a substantially uniform width through a portion thereof arranged at the inner portion of the shaft 4 over to the bending portion 7 and a portion thereof arranged at the outer portion of the shaft 4 to thereby prevent a narrowed portion from being produced in the flow path. The heat pipe 5 having such a shape is configured by, for example, bending the heat pipe 5 in a shape of a straight pipe. According to the embodiment, two of the heat pipes 5 are arranged in the electrical machine 1. A working fluid 6 is contained at an inner portion of the heat pipe 5.

In a case of two of the heat pipes 5 as in the present embodiment, the heat pipes 5 are arranged along the rotational axis in point symmetry in view from a long axis direction of the shaft 4. On the other hand, in a case of three or more of the heat pipes 5, stable high speed rotation is achieved by rotationally balancing the heat pipes 5 by arranging the heat pipes 5 in a shape of a regular polygon having a number of angles the same as a number of the heat pipes 5 centering on the rotational axis. Although in a case of two of the heat pipes 5, a regular polygon shape cannot be configured, and therefore, the case is classified as described above, otherwise, the case can also be classified as follows. That is, in a case where a number of the heat pipes 5 is an even number, the plural heat pipes 5 are arranged substantially in point symmetry with respect to the shaft 4 (more accurately, rotational axis), and in a case where the number of the heat pipes 5 is an odd number, the plural heat pipes 5 are arranged substantially in a shape of a regular polygon in view from an axial direction of the shaft 4.

The working fluid 6 contained at an inner portion of the heat pipe 5 sticks to an outer peripheral side of the heat pipe 5 since the working fluid 6 is exerted with a centrifugal force in a diameter direction at high speed rotation of the electrical machine. However, the radius of gyration of the condenser 9 is smaller than that of the evaporator 8, and therefore, the working fluid 6 is moved to the evaporator 8 which is disposed further on an outer side in the diameter direction. Therefore, the working fluid 6 does not stick to the condenser 9. Therefore, a thermal resistance does not increase with regard to a portion which is intended to cool even at an inner portion of the electrical machine 1, and a thermal conductivity of the heat pipe is not reduced even when the electrical machine is at high speed rotation. Therefore, the cooling performance can be improved.

According to the embodiment, a heat discharge amount from the condenser 9 of the heat pipe is increased by increasing the thermal conductivity by producing convection by agitating air at a surrounding of the condenser 9 in rotation by decentering the condenser 9 of the heat pipe 5. Also, the flow path of the heat pipe 5 is not narrowed, a fluid resistance is not increased, and therefore, the thermal conductivity at the heat pipe 5 is not reduced. The heat pipe 5 of the present embodiment is fabricated by bending a straight pipe, and therefore, the fabrication is made to be easier than fabrication of the heat pipe having a special shape of a tapered pipe, a pipe having different diameters or the like.

### Second Embodiment

A second embodiment will be explained in reference to FIG. 3. Incidentally, an explanation will be omitted of a portion duplicated with that of the first embodiment. FIG. 3 shows a sectional view in an axial direction of a shaft portion at high speed rotation of a cooling apparatus of an electrical machine according to a second embodiment. According to the electrical machine of the present embodiment, cooling fins 12 are arranged at an outer periphery of the condenser 9 of the heat pipe 5 in addition to the structure explained in the first embodiment. An area of radiating heat from the heat pipe 5 is increased by the cooling fins 12 to thereby accelerate to cool the electrical machine. Incidentally, as a way of providing the cooling fins 12, the condensers 9 of the plural heat pipes 5 may summarizingly be fixed by the single cooling fin 12. An effect of preventing a deformation by the centrifugal force is also achieved by covering a surrounding portion of the heat pipe 5 by the cooling fin(s) 12.

### Third Embodiment

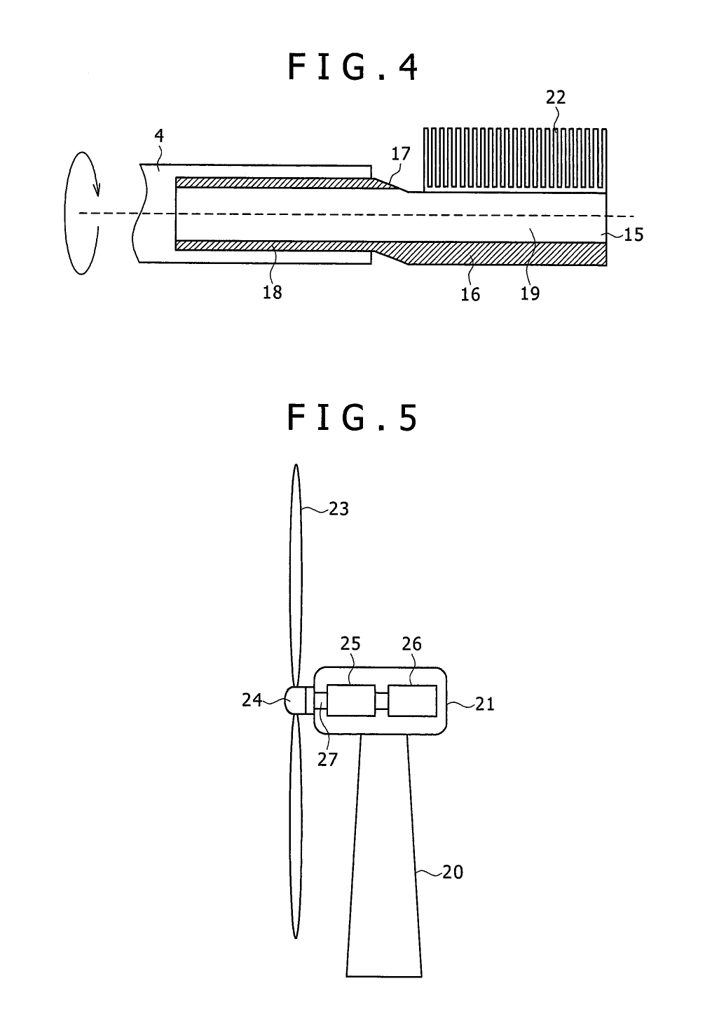

A third embodiment will be explained in reference to FIG. 4. An explanation in this embodiment will be omitted with regard to a portion duplicated with portions of the respective embodiments. FIG. 4 shows a sectional view in an axial direction of a shaft portion at high speed rotation of a cooling apparatus of an electrical machine according to a third embodiment. Although the explanation has been given of a case of providing the plural heat pipes in the embodiments described above, according to the present embodiment, a single heat pipe 15 is provided. According to the heat pipe 15 of the present embodiment, an evaporator 18 arranged at the inner portion of the shaft 4 is not decentered, but a condenser 19 arranged at the outer portion of the shaft 4 is decentered from a rotational axis. Also, cooling fins 22 are arranged at an outer periphery of the condenser 19 decentered from the rotational axis on a side opposed to a bending portion 17. Not only an area of radiating heat is increased but also stable high speed rotation is realized by correcting a rotation balance deteriorated by decentering the condenser 19 and deviating a working fluid 16 by arranging the cooling fins 22 deviatedly in a direction opposed to a direction of bending the bending portion 17. According to the present embodiment, the explanation has been given of a case where the number of the heat pipes 15 is made to be single, the evaporator arranged at the inner portion of the shaft 4 is not decentered but the condenser 19 arranged at the outer portion of the shaft 4 is decentered from the rotational axis. However, naturally, the embodiment of the present invention is not limited to the specific mode and does not exclude a case where the number of the heat pipes is made to be plural or the evaporator 18 arranged at the inner portion of the shaft 4 is decentered. The rotation balance can be corrected when the cooling fin 22 is arranged on a side where a degree of an eccentricity of the heat pipe is small.

### Fourth Embodiment

A fourth embodiment will be explained in reference to FIG. 5. FIG. 5 shows an example of a wind power generating system mounted with the electrical machine explained in the embodiments described above as an electrical machine system 26. The electrical machine system 26 is mounted in a nacelle 21, and the nacelle 21 is supported by a tower 20. The nacelle 21 can be rotated to yaw substantially in a horizontal face with the tower 20 as an axis. A shaft of the electrical machine system 26 is connected to a main shaft 27 via a gearbox 25, and a blade 23 rotated by receiving a wind and the main shaft 27 are connected by a hub 24. Energy of a wind is converted into a rotational energy by rotating the blade 23 by receiving the wind. The rotational energy is transmitted to the gearbox 25 via the hub 24 and the main shaft 27, and is converted into an electric energy by the electrical machine system 26 by increasing a rotational speed to a speed suitable for power generation by the gearbox 25. Incidentally, an application range of the present invention is not limited to the wind power generating system explained in the present embodiment but can also be applied to, for example, a hydraulic power generation, an engine, a turbine or the like. Also, the gearbox 25 is not necessarily needed but a power can be generated at a desired frequency without increasing the speed by, for example, increasing a pole number of a rotor.

What is claimed is:

1. An electrical machine comprising:
a stator including a stator winding;
a rotor arranged on a side of an inner diameter of the stator with a clearance between the rotor and the stator;
a shaft fixed to the rotor and rotated along with the rotor; and
a heat pipe arranged from an inner portion over to an outer portion of the shaft,
wherein a radius of gyration of a portion of the heat pipe arranged at the outer portion of the shaft is smaller than a radius of gyration of a portion of the heat pipe arranged at the inner portion of the shaft.

2. An electrical machine comprising:
a stator including a stator winding;
a rotor arranged on a side of an inner diameter of the stator with a clearance between the rotor and the stator;
a shaft fixed to the rotor and rotated along with the rotor; and
a heat pipe arranged from an inner portion over to an outer portion of the shaft,
wherein a portion of the heat pipe arranged at the inner portion of the shaft is arranged to be decentered from a rotational axis of the shaft.

3. An electrical machine comprising:
a stator including a stator winding;
a rotor arranged on a side of an inner diameter of the stator with a clearance between the rotor and the stator;
a shaft fixed to the rotor and rotated along with the rotor; and
a heat pipe arranged from an inner portion over to an outer portion of the shaft,
wherein a portion of the heat pipe arranged at the outer portion of the shaft is arranged to be decentered from a rotational axis of the shaft.

4. The electrical machine according to claim 1, wherein a plurality of the heat pipes are provided;
wherein, when the number of the heat pipes is an even number, the heat pipes are arranged substantially in point symmetry with respect to the shaft; and
wherein, when the number of the heat pipes is an odd number, the heat pipes are arranged substantially in a shape of a regular polygon in view from a long axis direction of the shaft.

5. The electrical machine according to claim 2, wherein a plurality of the heat pipes are provided;
wherein, when the number of the heat pipes is an even number, the heat pipes are arranged substantially in point symmetry with respect to the shaft; and
wherein, when the number of the heat pipes is an odd number, the heat pipes are arranged substantially in a shape of a regular polygon in view from a long axis direction of the shaft.

6. The electrical machine according to claim 3, wherein a plurality of the heat pipes are provided;
wherein, when the number of pieces of the heat pipes is an even number, the heat pipes are arranged substantially in point symmetry with respect to the shaft; and
wherein, when the number of the heat pipes is an odd number, the heat pipes are arranged substantially in a shape of a regular polygon in view from a long axis direction of the shaft.

7. The electrical machine according to claim 1, wherein a surrounding of the portion of the heat pipe arranged at the outer portion of the shaft is covered by a cooling fin.

8. The electrical machine according to claim 2, wherein a surrounding of the portion of the heat pipe arranged at the outer portion of the shaft is covered by the cooling fin.

9. The electrical machine according to claim 3, wherein a surrounding of the portion of the heat pipe arranged at the outer portion of the shaft is covered by a cooling fin.

10. The electrical machine according to claim 7, wherein a plurality of the heat pipes are provided, and the cooling fin integrally covers surroundings of the heat pipes.

11. The electrical machine according to claim 8, wherein a plurality of the heat pipes are provided, and the cooling fin integrally covers surroundings of the heat pipes.

12. The electrical machine according to claim 9, wherein a plurality of the heat pipe are provided, and the cooling fin integrally covers surroundings of the heat pipes.

13. The electrical machine according to claim 7, wherein the cooling fin is arranged to an outer periphery of the portion arranged at the outer portion of the shaft and arranged to be decentered from the rotational axis of the shaft on a side opposed to the portion decentered to a side of an outer diameter in a diameter direction.

14. The electrical machine according to claim 8, wherein the cooling fin is arranged at an outer periphery of the portion arranged at the outer portion of the shaft and arranged to be decentered from the rotational axis of the shaft on a side opposed to the portion decentered to a side of an outer diameter in a diameter direction.

15. The electrical machine according to claim 9, wherein the cooling fin is arranged at an outer periphery of the portion arranged at the outer portion of the shaft and arranged to be decentered from the rotational axis of the shaft on a side opposed to the portion decentered to a side of an outer diameter in a diameter direction.

16. A wind power generating system comprising:
the electrical machine according to claim 1;
a blade rotated by receiving a wind; and
a main shaft rotated in accordance with a rotation of the blade,
wherein the rotor of the electrical machine is rotated by rotating the shaft in accordance with a rotation of the main shaft.
